(19) United States
(12) Patent Application Publication
(10) Pub. No.: US 2019/0242364 A1
(43) Pub. Date: Aug. 8, 2019

(54) Determining loads on a wind turbine

(71) Applicant: ROMAX TECHNOLOGY LIMITED, Nottingham (GB)

(72) Inventors: Evgenia Golysheva, Nottingham (GB); Andy Poon, Nottingham (GB)

(21) Appl. No.: 16/341,936

(22) PCT Filed: Oct. 9, 2017
(86) PCT No.: PCT/IB2017/056230

§ 371 Date: Apr. 15, 2019

(30) Foreign Application Priority Data
Oct. 17, 2016 (GB) 1617584.6

(51) Int. Cl. F03D 7/04; F03D 17/00

(52) U.S. Cl. CPC F03D 7/048; F03D 17/00; F05B 2260/84; F05B 2270/331; F05B 2260/821

(57) ABSTRACT

A computer-related method for estimating turbine hub loads in a windpark comprising a plurality of turbines, the method comprising the steps of: providing a 3D airflow database; providing a turbine loads transfer function; measuring turbine operating data for each turbine; and processing turbine operating data using the 3D airflow database and the turbine loads transfer function. This allows wind turbine loads are indirectly obtained in real time without the need of additional turbine instrumentation thereby reducing the cost of such system.

### TECHNICAL FIELD

The present invention relates to approaches for designing wind farm layouts.

### BACKGROUND ART

Wind turbines with more compact and sophisticated drivetrains and larger rotors are being installed in locations with more challenging wind conditions increasing risk of premature failure of turbine components due to incorrect design, excessive loading or non-optimised operation. Accurate estimation of the turbine loads becomes even more important. It is possible to instrument the turbine in order to measure such loads, however the cost of hardware and subsequent integration and data analysis is usually prohibitively expensive. The alternative approach could be instrumenting one or two turbines and extrapolating the data to the rest of the wind park. However, such approach while still being useful for relatively steady wind conditions, does not capture many important transient wind conditions for example turbulence, wake effects or wind shear. Wind park CFD modelling could provide this information, but is too computationally intensive to be practical.

### BRIEF DESCRIPTION OF THE INVENTION

The proposed method allows more representative, cost effective and faster estimation of turbine loads using wind loading model developed using wind park level modelling and wind park SCADA data. Results of such model can then be used as an input into turbine level aeroelastic load model converting wind regime experienced by turbine into drivetrain loads. Resulting turbine loading model can be used for on-line or off-line turbine loads calculations and does not require permanent turbine instrumentation.

The invention is easily implemented and computationally efficient because intensive CFD and aeroelastic modelling is replaced by 3D airflow database and turbine loads transfer function developed offline.

### BRIEF DESCRIPTION OF DRAWINGS

The invention will now be described with reference to the drawings, in which:

FIG. 1 shows an overview block diagram of the information flow for wind turbine load estimation;

FIG. 2 shows an example of how 3D airflow database 150 is constructed; and

FIG. 2 shows a turbine loads transfer function.

### DETAILED DESCRIPTION OF THE INVENTION

In the following, the term “windpark” can mean an area in which wind turbines are located, or an area in which wind turbines are proposed to be located.

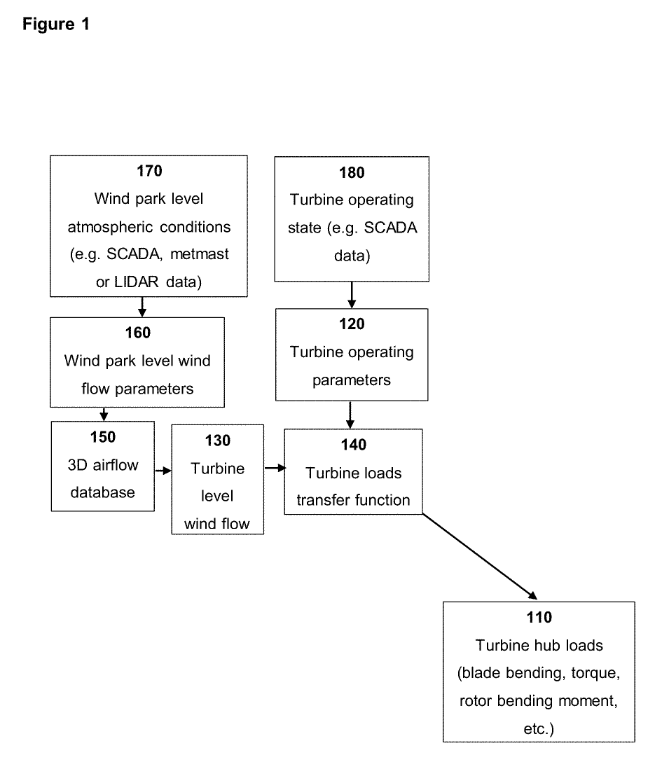

Referring now to FIG. 1, which shows an overview block diagram of the information flow for wind turbine load estimation, turbine hub loads 110, including loads such as blade bending, torque, rotor and bending moment, are determined from turbine operating parameters 120 from one or more turbines and turbine level wind flow 130 using a turbine loads transfer function 140.

Turbine level wind flow 130 is obtained from 3D wind flow database 150 and windpark level wind flow parameters 160. Windpark level wind flow parameters 160 include wind speed, wind direction, turbulence, ambient temperature and air density and are obtained from wind park level atmospheric conditions 170. For an existing windpark, these parameters can be obtained from, for example, SCADA, met-mast or LIDAR data. For example, data from anemometers or other wind-sensing sensors mounted on a wind turbine may be used. For a windpark under development, these parameters can be from met masts located at proposed locations of the wind turbines. It is important to note that 3D wind flow database 150 is constructed from data relating to turbine level wind flow 130 at one or more turbines at different locations in the wind farm under a range of wind park atmospheric conditions. Typically this is previously obtained wind park atmospheric conditions. Typically 3D wind flow database 150 is a look-up table.

Turbine operating parameters 120 are obtained from turbine operating state 180, typical derived from SCADA data.

It will be appreciated that turbine loads transfer function 140 is specific to the turbine and wind flow . . . .

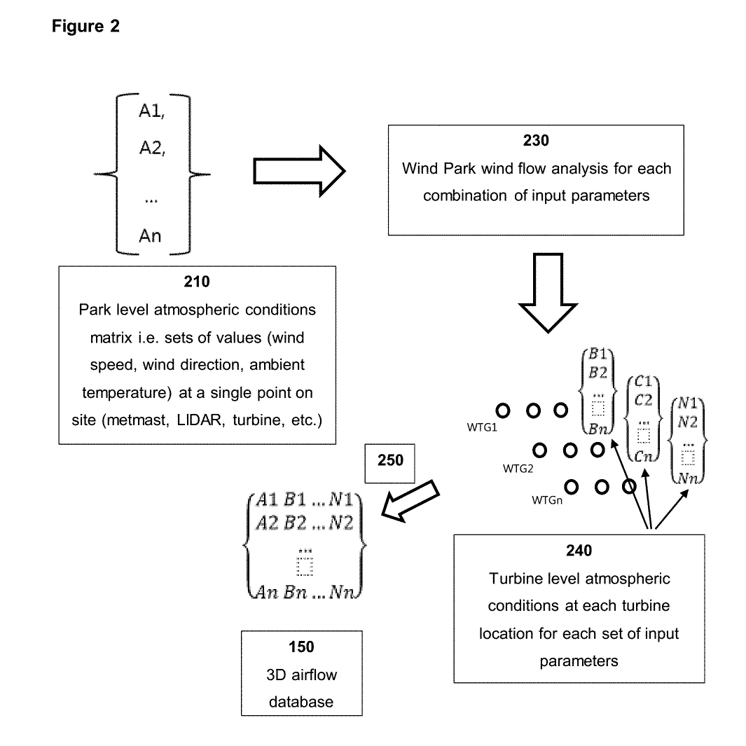

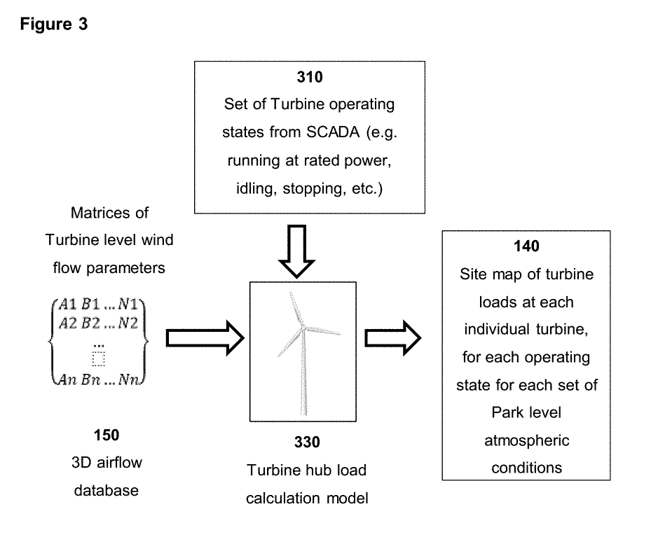

Referring now to FIG. 2, which shows an example of how 3D airflow database 150 is constructed, in a first step 210 a matrix A₁ to Aₙ of windpark level atmospheric conditions at a single point on the windpark site is collected. These approaches are well-known, and other similar methods can be used. The matrices of windpark level wind inflow and atmospheric conditions might include, but not limited to air density, air temperature, wind direction, mean wind speed, wind turbulence, are used. The single point can be a metmast, a turbine or a LIDAR installation. In a second step 210, the matrices are analysed using, for example a CFD model, such as a continuity model or other modelling approach. In a third step 240, the wind park wind flow analysis is performed for each combination of input parameters to yield turbine level atmospheric conditions for each set of input parameters, B₁ to Bₙ, C₁ to Cₙ, D₁ to Dₙ, etc. From this, in step 250, the 3D airflow database is constructed. Thus using simulations results a 3D wind loads database is developed which maps wind conditions at Turbine level for each individual turbine at the wind park to multiple Park level atmospheric conditions. The output of this model can be a look up table, a database, a statistical model or a meta-model developed using results of CFD simulations.

Once constructed, the 3D airflow database can be used ‘offline’, for example, as a look-up table, with real-time turbine operating data to give real-time hub-loading data. This eliminates the need for intensive CFD modelling of incoming wind airflow data in real time.

FIG. 3 shows a turbine loads transfer function. This uses Turbine level wind conditions to calculate turbine hub loads for each operating regime of the turbine (for example, running at rated power, idling, shutting down) at each wind condition. This could be done using turbine aero elastic model (either developed in-house or using one of the commercially available packages like FAST, Bladed, etc.) or some other calculation methods.

If necessary, the model can be tuned further using instrumentation campaign where one or more turbines in selected locations are instrumented with load measurements hardware for a limited period of time.

Resulting model allows to estimate wind turbine hub loads faster (because it substitutes computationally intensive wind park CFD modelling and turbine hub loads calculations with databases developed off-line, more accurately (because it captures transient atmospheric conditions through CFD modelling) and in a cost effective way (no additional load measuring equipment is required) using readily available wind park level wind conditions and turbine SCADA data. Wind park level wind conditions can be measured using metmasts or estimated from the SCADA data from the most appropriate turbines (depending on the wind direction and turbine operation).

Advantages of this approach include the following outcomes:

Estimated turbine loads include loads due to wind turbulence and wind shear by using readily available SCADA data and without an additional instrumentation.

The resulting model can be used as look up table or a function in combination with turbine controller data for on-line load calculations.

This method can be used during wind park planning and design stage to optimise turbine locations producing maximum power while minimising damage from operating loads. This means that the approach can be used for designing a wind park layout using the approach described above in a method comprising the steps of:
providing a 3D airflow database;
providing a turbine loads transfer function;
measuring turbine operating data for each turbine; and
processing turbine operating data using the 3D airflow database and the turbine loads transfer function;
wherein wind turbine loads are indirectly obtained in real time without the need of additional turbine instrumentation and a design for the layout of the wind turbines in the farm is produced.

Combined with long-term wind assessment for the wind park and damage calculations for the turbine components, method can be used for the useful life assessment for turbine components.

The method can be used for defining wind turbine control strategies optimal for the wind park (e.g. maximise power production while optimising damage accumulation, extend the useful life of turbine components, etc.)

1: A method for estimating turbine hub loads in a windpark comprising a plurality of turbines, the method comprising the steps of:
providing a 3D airflow database;
providing a turbine loads transfer function;
measuring turbine operating data for each turbine; and
processing turbine operating data using the 3D airflow database and the turbine loads transfer function;
wherein wind turbine loads are indirectly obtained in real time without the need of additional turbine instrumentation thereby reducing the cost of such system.

2: A method for estimating turbine hub loads in a windpark according to claim 1, in which the 3D airflow database is constructed according to the method of:
forming a matrix of windpark level atmospheric conditions at a single point on the windpark site; and
analysing the matrix for each combination of input parameters to give turbine level atmospheric conditions at each turbine location for each set of input parameters.

3: A method for estimating turbine hub loads in a windpark according to claim 1, in which the step of analysing the matrix is a computational fluid dynamics analysis.

4: A method for estimating turbine hub loads in a windpark according to claim 1, in which the turbine loads transfer function is a site map of turbine loads at each individual turbine, for each operating state for each set of Park level atmospheric conditions.

5: A method for designing a layout for a windpark comprising the steps of:
(a) for each turbine in the windpark, estimate turbine hub loads according to the method of claim 1;
(b) change the layout to balance power production against load for each of the turbines;
repeat steps (a) and (b) to optimise power production against load for the windfarm.

6: A method for operating a wind turbine comprising the steps of: for the turbine, estimate turbine hub loads according to the method of claim 1;
balancing power production and/or operations and maintenance cost based on the turbine load without additional instrumentation.

7. (canceled)

9: A system for estimating hub loads in a windpark comprising:
a 3D airflow database;
a turbine loads transfer function module;
an input for receiving real-time turbine operating data for each turbine;
wherein the turbine loads transfer function module transforms the turbine operating data into real-time loading data using the 3D airflow database.

10: A computer implemented method of designing a layout of wind turbines in a wind park, the method comprising the steps of:
providing a 3D airflow database;
providing a turbine loads transfer function;
measuring turbine operating data for each turbine; and
processing turbine operating data using the 3D airflow database and the turbine loads transfer function;
wherein wind turbine loads are indirectly obtained in real time without the need of additional turbine instrumentation and a design for the layout of the wind turbines in the farm is produced.
